(19) United States
(12) Patent Application Publication
(10) Pub. No.: US 2018/0064041 A1
(43) Pub. Date: Mar. 8, 2018

(54) GROWING SYSTEM

(71) Applicant: Neotune's Gardens, lnc., Incline Village, NV (US)

(72) Inventors: Jeremiah Will Brigham, Incline Village, NV (US); Richard D. Kurtiz, Reno, NV (US)

(73) Assignee: Neotune's Gardens, lnc., Incline Village, NV (US)

(21) Appl. No.: 15/694,922

(22) Filed: Sep. 4, 2017

Related U.S. Application Data
(60) Provisional application No. 62/383,109, filed on Sep. 2, 2016.

(51) Int. Cl. A01G 27/00; A01G 9/02; A01G 27/04

(52) U.S. Cl. CPC A01G 27/005; A01G 27/04; A01G 9/027

(57) ABSTRACT

A plant growing system is provided comprising a trough and at least one pot. The trough holds water and at least one opening is provided on an upper portion of the trough. The pot is configured to hold plant media and at least one plant and to be placed so that the trough is received at least partially within a channel. A wicking system is provided in the pot that extends into the opening and transports liquid from the trough to the interior of the pot thereby providing water and nutrients to the plant. A plurality of pots may be placed along the length of the trough to simultaneously water a purity of plants. A float switch may be provided for automatically adding water to the trough when the water level drops below a predetermined level.

### FIELD OF THE INVENTION

The present invention relates to plant growing systems and in particular to self-watering systems for growing potted plants.

### BACKGROUND

Self watering systems are beneficial for growing potted plants in commercial environments. For example, these systems are useful for growing seedlings and plants for retail sale or growing consumable plants, such as herbs, vegetables, etc. By providing a self-watering system, labor intensive management of the growing system may be reduced. Self-watering systems are also used by hobby and domestic gardeners.

Existing self watering systems can be complex and costly and provide little flexibility. What is required is an improved watering system.

### BRIEF DESCRIPTION OF ONE EMBODIMENT OF THE PRESENT INVENTION

In one aspect of the present invention, there is a provided a watering system comprising a trough system and at least one pot. The trough system may include a trough section that is able to retain a level of fluid within the trough section. The trough section may have an input end that connects to a fluid source. A control valve may be disposed toward the input end of the trough section. The control valve may control a fluid level within the trough. A plurality of engagement sites may be spaced along a length of the trough section. The at least one pot may include one or more walls that define a receptacle for receiving a growing medium and at least one plant. A channel may be formed in the lower section of the pot that is configured to straddle the trough at an engagement site. A wicking system may extend into the channel such that when the pot straddles the trough at the engagement site, the wicking system facilitates wicking of fluid within the trough to the receptacle.

In one aspect, there is provided a pot for use with a trough of a watering system. The pot may include one or more walls that define a receptacle for receiving a growing medium and at least one plant. A channel may be formed in the lower section of the pot that is configured to straddle the trough at an engagement site of the trough. A wicking system may extend into the channel such that when the pot straddles the trough at the engagement site, the wicking system facilitates wicking of fluid within the trough to the receptacle.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially shows a schematic perspective view of a watering system;

FIG. 2 substantially shows a perspective view of a trough for a watering system;

FIG. 3 substantially shows cross-sectional view of a base of the trough;

FIG. 4 substantially shows a side view of a pot for the watering system;

FIG. 5 substantially shows a perspective view of the pot with the outer walls of the pot partially transparent;

FIG. 6 substantially shows a top view of the pot with the wicking system removed;

FIG. 7 substantially shows a perspective view of a basket; and

FIG. 8 substantially shows a top view of the basket.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

In various embodiments, the present invention is able to provide plants with a passive, compact, self watering irrigation system that can be utilized by a multitude of growing modalities, including traditional potting soil, light weight organic super soil, and soil-less media. This extremely water efficient system can provide the ideal amount of hydration to plants without requiring electricity, and can work with both traditional water line hook ups, or with independent freestanding reservoirs. A reservoir can be used in spaces where a conventional house spigot or water line is not convenient, or in situations where natural water sources are preferred (i.e., spring water, pond water, rain water, etc.).

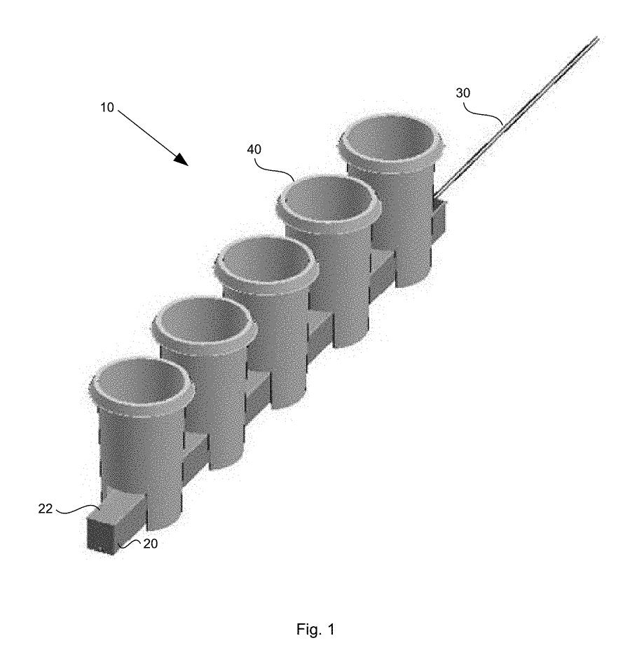

In FIG. 1, there is shown a watering system in accordance with one embodiment of the invention. The watering system 10 includes a water trough 20 that is provided with water or fluid by a supply line 30 that connects at a supply end to a reservoir. As viewed from the top, trough 20 may have a substantially rectangular shape with parallel side walls and a longitudinal axis. However, it is recognized that trough 20 could have a large variety of other shapes, such as an arc shape, a circular shape and a toroid shape.

Trough 20 has a trough cap 22 with holes or apertures formed along it. Pots 40 are disposed over the trough with a watering element of the pot, described in more detail below, extending into the holes of the trough cap to allow soil or similar media in the pot to contact the fluid and conduct the fluid into the pot by osmosis.

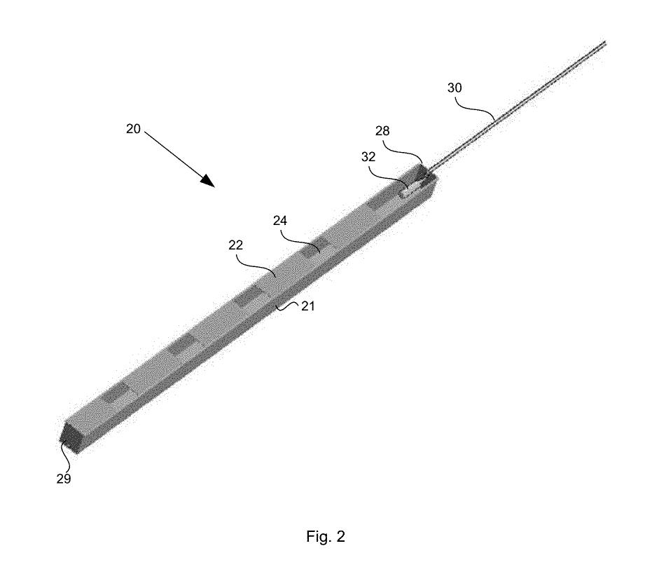

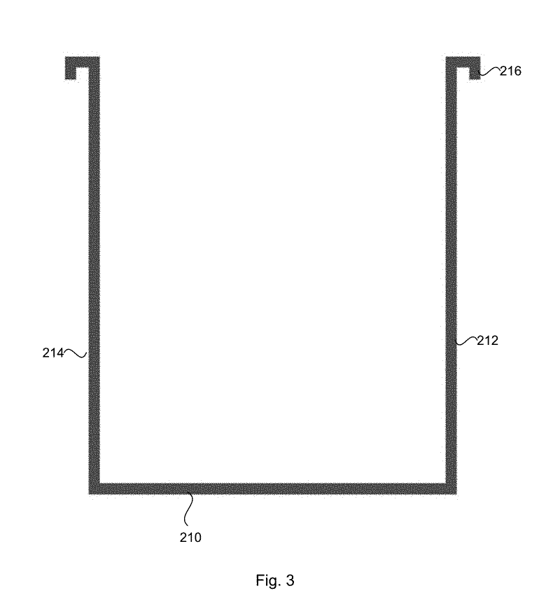

The water trough 20 is shown in more detail in FIGS. 2 and 3 and includes a base 21 which may be square, rectangular, circular, semi-circular, or any desired shape. In one particular embodiment shown in FIG. 3, the water trough has an end section that is square or rectangular and thus has a bottom wall 210 and side walls 212, 214 extending upwards from the bottom wall 210. The upper edge of the side walls 212, 214 may include a lip 216 that facilitates engagement with the trough cap 22. In an alternative embodiment (not shown), the inner surface of the side walls 212, 214 may include a shelf or edge near the top of the side walls that allows the trough cap to rest on the shelf. The base 21 is able to hold and retain fluid within the base. The trough 20 has an associated trough cap 22 that covers the trough base 21 to provide a closed system. In one embodiment, the trough cap 22 snaps on to secure the trough cap 22 to the trough base 21. In other embodiments, the trough cap 22 may rest on the trough base 21 or may have walls that nest within or outside the side walls of the trough base 21. It will be appreciated by the person skilled in the art that various engagement mechanisms between the trough base 21 and trough cap 22 may be employed.

Base 21 and cap 22 may be made using a wide variety of materials and methods. In one embodiment, base 21 is extruded plastic, such as polyethylene or polypropylene, and end caps 29 are welded onto the ends of the trough. In another embodiment, all of the components are injected molded plastic.

The trough cap 22 has holes or cutouts 24 spaced along the length of the trough cap 22. These holes 24 provide engagement sites for receiving and engaging with a pot as will be described in further detail below. The holes 24 may be irregularly spaced or customizable though in one particular embodiment, the holes are evenly spaced. Various trough caps with differently spaced holes may be provided to allow flexibility in the number and spacing of pot engagement sites according to the particular plant requirements. This allows for an extremely efficient layout of planting sights to maximize growth space, thereby saving lighting energy. In a further embodiment, the trough cap 22 may be comprised of individual sections that can be individually placed on the trough base to provide a variable hole width and variable hole spacing.

The modular trough system 20 has a water input end 28 that connects to a fluid source via a fluid supply line 30. The fluid source may be water pipe supply or fluid reservoir such as a tank. The fluid source may provide water only or may be a supply of water that contains additives, such as nutrients.

At the opposite end to the water input end, the trough 20 is provided with a water tight insert end cap 29 that closes the trough 20 to seal the fluid within the trough. The end cap 29 is removable and the trough system 20 is configured at the end for modular assembly of additional lengths of the trough system, thereby allowing a single trough to be expanded to a large custom system encompassing hundreds of troughs and planting sights that can meet the needs of various plant growing operations, both domestic and commercial.

Toward the water inlet end 28, the trough is provided with a control valve 32 that controls the flow of fluid into the trough 20. In one embodiment, the control valve 32 is a manual float valve that can disposed anywhere between the water inlet end 28 and the first opening 24 along trough 20. The float valve is configured to open when the float falls below a configurable level within the trough 20 to allow additional fluid from the fluid source 30 to enter the trough 20.

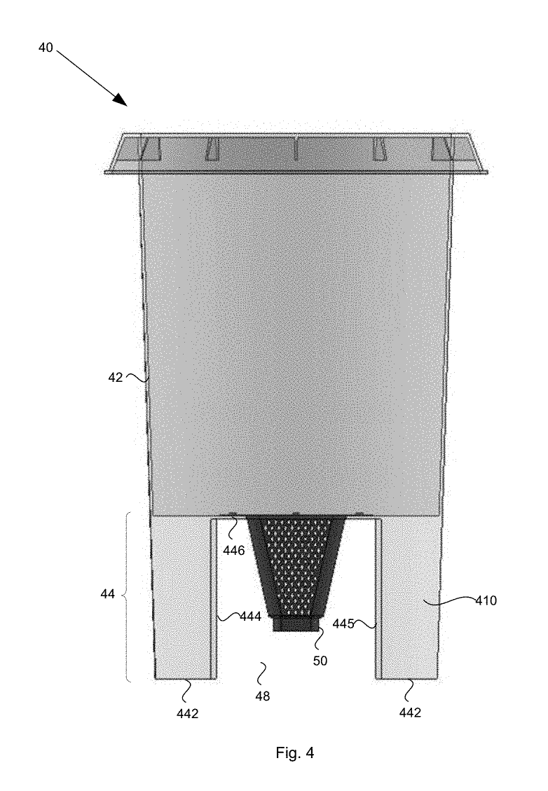

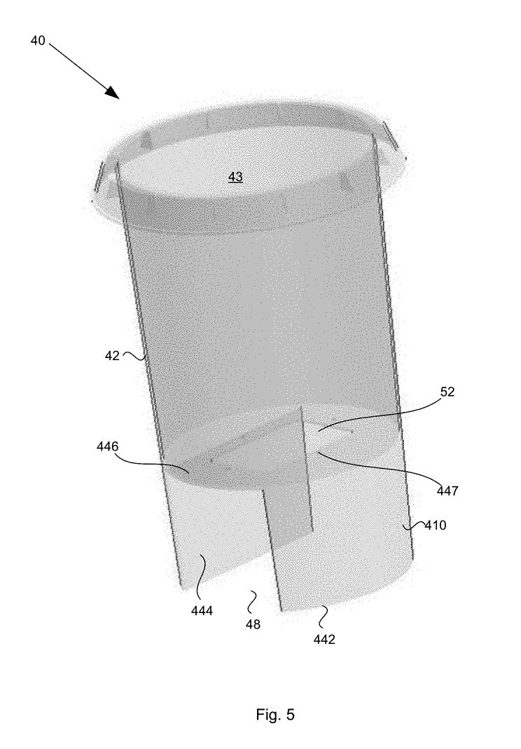

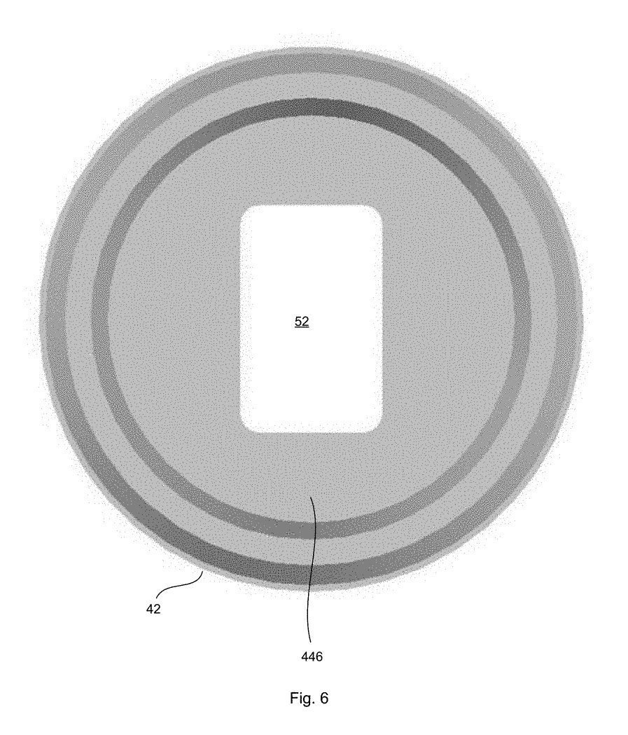

As outlined above, the engagement sites provided at the cutout locations 24 allow engagement with pots 40. A single pot 40 is shown in FIGS. 4-8. The pot 40 includes a side wall 42 that may be of any desired shape. In one embodiment, pot 40 is a substantially cylindrical shape. The pot further includes a base portion 44 that will be described in further detail below. Together, base 44 and side wall(s) 42 form a receptacle 43 for receiving a growing medium and at least one plant. Various growing mediums can be used with the water system, including traditional potting soil, light weight organic super soil, and soil-less media, such as pebbles or gravel.

The base section 44 of the pot is shaped to create a channel 48 in the exterior surface of the base 44 that accepts the trough 20 within the channel. The channel 48 is defined by two inner straight side walls 444, 445 that extend upwards of the lower surface 442 of the pot to an upper wall 446 that forms a portion of the bottom of the receptacle 43. The side walls of the channel 444, 445 allow the pot 40 to straddle the trough 20 with the trough passing through the channel 48. The channel side walls 444, 445, base surface 442 and pot side wall 42 form legs 410 that allow the pot to rest on a surface of the ground, making the pot 40 stable after being filled with soil or other planting media. Legs 410 may not extend all the way to the ground and the pot 40 may be supported only by trough 20. The wall 446 may extend across the entire bottom of the receptacle 43 between the side walls 42 to close off the legs 410 from the receptacle space 43. Alternatively, wall 446 may extend only between the channel side walls 444, 445 to leave the internal spaces defined by the legs 410 open, allowing these spaces to be filled with additional plant media and the root systems of the plants. Legs 410 may abut walls 212 and 214 of trough 20 to support the trough and to prevent relative movement between the pot and the trough.

In the middle of the channel 48, the base is provided with a wicking system. In one embodiment, the wicking system includes a support structure 50 that extends below a hole 52 in the upper surface 446 of the channel that extends from the channel through to the receptacle. The support structure is able to support plant media from the receptacle 43 that falls through the hole 52. The support structure may be flexible or rigid and may be attached to or integrally formed with the base 44. In one embodiment, the support structure may be a flexible webbing, net or basket with holes or perforations that allows fluid from the trough to enter. In an alternative embodiment, the support structure may be a rigid perforated support structure that is molded as a part of the base.

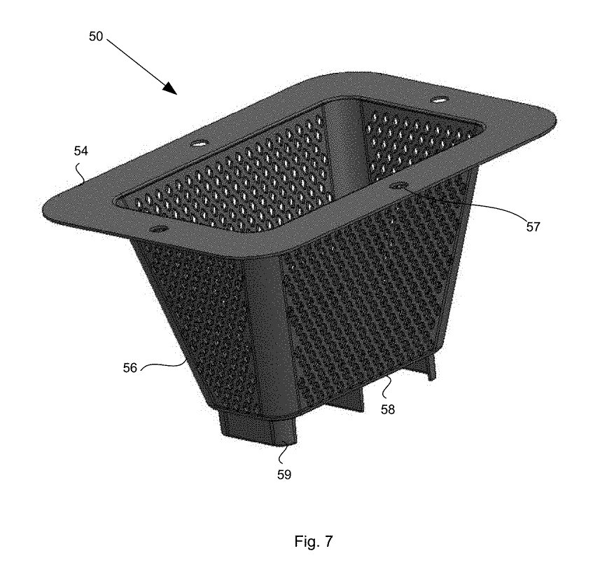

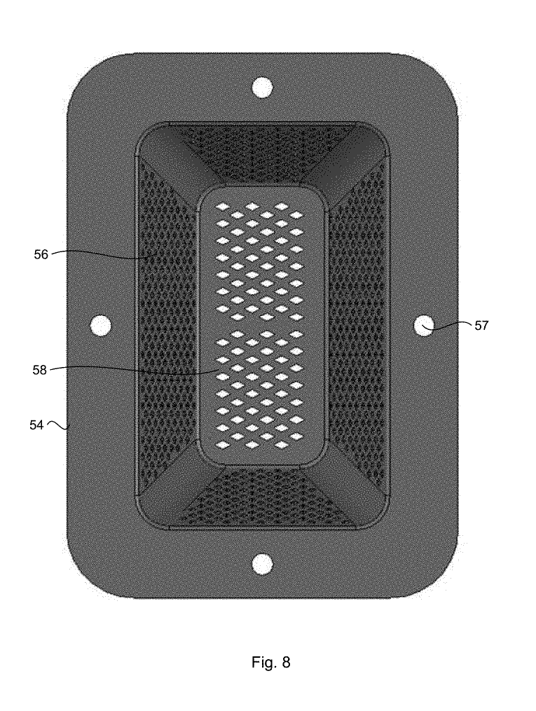

A particular embodiment of the support structure is depicted in FIGS. 7 and 8. The support structure 50 is a removable basket that may be made of plastic in a molding or similar forming process. Other materials, including metal, fibers, etc., may also be used. The basket 50 includes an upper horizontal flange 54 that is wider than the hole 52 in the pot 40. Sloping meshed walls 56 extend below the flange 54 to a bottom meshed wall 58. One or more ribs 59 extend below the meshed bottom wall which may prevent the bottom of the basket from resting on the floor of the trough. The series of holes formed by the meshed walls allows fluid to penetrate into the basket.

At the junction between the walls 56 and flange 54, the space between the walls is narrower than the hole 52, thereby allowing the basket 50 to be lowered into the pot 40 through the receptacle with the flange coming to rest against the inner surface of the wall 446 that defines the hole 52 and with the basket walls 56 extending below the pot wall 446 and into the channel 48. While it is not essential to secure the basket 50 to the pot 40, the flange 54 and wall 446 may be provided with alignable holes 57, 449 that allows the basket to be secured to the pot using rivets, screws or similar fasteners. Alternatively, the basket 50 may be secured to the pot 40 using adhesives. Once the basket 50 is located within the pot 40, the pot receptacle 43, including the space within the basket 50, may be filled with a plant growing medium and one or more plants may be planted in the plant growing medium.

The wicking system is configured so that when the pot straddles the trough, the support structure 50 and the plant medium it contains passes into the trough through a hole 24 in the trough cap 22. The fluid in the trough passes through the holes in the support structure to flood the plant medium up to the height of the fluid within the trough. A capillary action causes fluid to be transited through the receptacle of pot 40 where it can be absorbed by the root system of the plant. As the water in the trough is consumed the water level in the trough lowers. When the water is depleted to a preset level, the float valve automatically activates to refill the trough to an upper preset level, maintaining a suitable level of water.

In a further embodiment, the wicking system may include a physical wicking member that hangs into the channel to pass into the trough and also contacts the plant media in the pot receptacle so that the wicking member can wick moisture from the trough to the plant media.

The presently described system provides substantial advantage over prior art watering systems. For example, a single float valve can control a large number of plant sites. This is less expensive and more efficient than systems that require a control valve at every plant site. A further advantage is that the present invention is less likely to be clogged because the trough is wide and the control valve is upstream of all plant sites. Fluid is able to flow past each of the plant sites to reach all of the plants. A further advantage is that the pots can be easily removed, replaced and reorganized because there is no physical coupling between the pot and the watering system.

The system herein described provides the benefits of self-watering hydroponic systems without the need for electricity. The enclosed trough system helps to maintain proper humidity in the room by limiting the ability of excess water vapor from escaping the trough system. The pot design may further incorporate a bucket cap that limits transpiration of water vapor from the soil to the environment, thereby conserving water.

In addition to its value of providing the hobby gardener with an easy to use self-watering growing method, this system can save commercial facilities tremendous amounts of labor and electricity.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A watering system comprising:
(A) a trough, the trough comprising:
(a) a first side wall;
(b) a second side wall, wherein fluid may be held in the trough between the first and second side walls; and
(c) at least one opening in the trough; and
(B) at least one pot comprising:
(a) one or more walls that define a receptacle space configured to hold a growing medium and at least one plant;
(b) a channel formed in a lower section of the pot, the channel configured to at least partially receive the trough; and
(c) at least one wicking system that extends into the channel such that when the pot is positioned on the trough, the wicking system extends into the trough through the opening of the trough and transports fluid.

2. The watering system of claim 1, further comprising a second pot the second pot comprising:
(A) one or more walls that define a receptacle space for receiving a growing medium and at least one plant;
(B) a channel formed in a lower section of the pot, the channel configured to straddle the trough; and
(C) at least one wicking system that extends into the channel such that when the pot straddles the trough, the wicking system extends into the trough through the opening of the trough, wherein the at least one pot and the second pot may be simultaneously positioned on the trough.

3. The watering system of claim 1, further comprising at least one cap, the cap covering at least a portion of the opening of the trough.

4. The watering system of claim 1, wherein the trough has a substantially rectangular shape and the first and second side walls are substantially parallel.

5. The watering system of claim 1, wherein the at least one pot comprises at least one leg that supports the pot from a surface when the pot is positioned to straddle the trough.

6. The watering system of claim 1, where the wicking system comprises a support structure, the support structure being configured to support plant media in the pot.

7. The watering system of claim 6, wherein the pot comprises a bottom hole, wherein support structure is adapted to be placed in the hole.

8. The watering system of claim 1, wherein the channel of the pot is formed at least in part from a first and second leg, the first and second leg extending to a ground surface when the pot straddles the trough.

9. The watering system of claim 8, wherein the first and second legs abut the first and second side walls of the trough when the pot straddles the trough.

10. The watering system of claim 1, wherein the pot may be placed a plurality of positions along a length of the trough.

11. A pot comprising:
(A) one or more walls that define a receptacle space for receiving a growing medium and at least one plant;
(B) a channel formed in a lower section of the pot, the channel configured to straddle a trough, the trough having an opening; and
(C) at least one wicking system that extends into the channel such that when the pot straddles the trough the wicking system enters the trough through the opening.

12. The pot of claim 10, further comprising at least one leg, the leg being configured to at least partially support the pot from a ground surface.

13. The pot of claim 10, wherein the channel is formed at least in part from a first and second leg, the first and second leg extending to a ground surface when the pot straddles the trough.

14. The pot of claim 10, where the wicking system comprises a support structure, the support structure being configured to support plant media in the pot.

15. The pot of claim 13, wherein the pot comprises a bottom hole, wherein support structure is adapted to be removably positioned in the pot and extend through the hole.

16. An irrigation system for delivering water to plants, the irrigation system comprising:
(A) trough means for holding water and providing access to the water at a plurality of horizontal positions;
(B) a plurality of pot means for holding plants at the plurality of horizontal positions.

17. The irrigation system of claim 16, wherein the plurality of pot means comprise wicking means for transporting water from the trough to an inside of the pot.

18. The irrigation system of claim 17 further comprising support means for supporting plant media in the pot means.

19. The irrigation system of claim 16 further comprising automatic water control meals for automatically adding water to the trough means.

20. The irrigation system of claim 16 further comprising cap means for covering openings in the trough.
